(19) United States
(12) Patent Application Publication
(10) Pub. No.: US 2009/0211999 A1
(43) Pub. Date: Aug. 27, 2009

(54) Underwater deployment system

(76) Inventor: David Webster, Monmouth (GB)

Correspondence Address: BRACEWELL & GIULIANI LLP, P.O. BOX 61389, HOUSTON, TX, 77208-1389, US

(21) Appl. No.: 11/920,579

(22) PCT Filed: Mar. 21, 2006
(86) PCT No.: PCT/GB2006/001010

§ 371 Date: Nov. 26, 2008

(30) Foreign Application Priority Data
May 18, 2005 (GB) 0510080.5

(51) Int. Cl. B66C 23/53

(52) U.S. Cl. 212/308

(57) ABSTRACT

Apparatus for deployment from a base for installing a component (1) at an underwater facility (6), comprises a carriage (2) for suspension from the base in use of the apparatus, the carriage (2) being adapted to releasably retain the component (1) and damping means (7) located between the carriage (2) and the base in use for resisting relative motion of the carriage (2) and facility (6) caused by substantially vertical motion of the base.

This invention relates to an apparatus and a method for facilitating the installation of a component at an underwater facility, such as a hydrocarbon production facility or well.

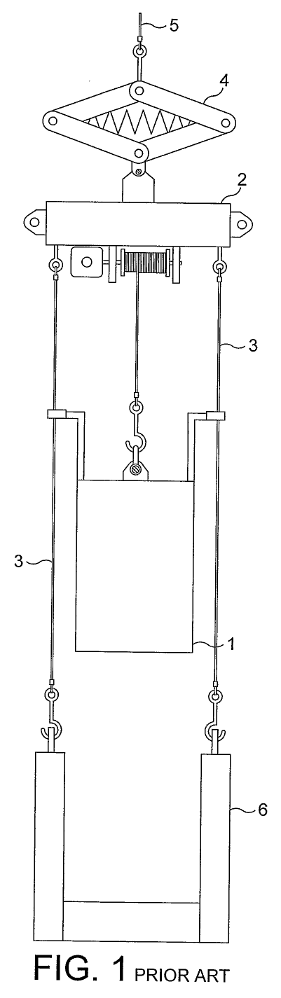

The installation of equipment for subsea fluid extraction or injection wells involves the lowering of heavy assemblies on to the sea bed. It is particularly difficult to lower components such as subsea control modules to locate on structures already on the sea bed, such as a well tree, as considerable positional accuracy is required. The lowering of such components is normally effected from a surface vessel, in conjunction with the use of a subsea Remote Operated Vehicle (ROV). However, the surface vessel is subjected to the conditions of the surface sea state, causing the vessel to move in pitch, yaw and heave. A system for compensating for these movements is described in Patent Application No. GB 0402415.4. FIG. 1 shows an arrangement for a deployment stack as described in this application at the deployment stage where an assembly 1 is ready for installation. The deployment stack apparatus consists of a hoist carriage 2 and two guide wires 3, attached to an extendable parallelogram linkage 4, the whole being supported by a cable 5 attached to a winch at the stern of the vessel. The guide wires 3 are attached to a fixed subsea base 6, typically a tree pod location point, and the cable 5 is tensioned so that the parallelogram linkage is in the middle of its dynamic range. With the guide wires 3 tensioned, the assembly 1 is lowered to the subsea base 6 to complete its installation. Additional linkages may be provided in series with the first to accommodate greater amplitudes of heave.

However, it is possible that in some circumstances this system may be unstable and prone to low frequency oscillation, particularly in the vertical axis. This is due primarily to the elasticity of the deployment lines and inadequate damping from the friction of the deployed assembly in the water. Furthermore, there is always the risk that a peak in the vessel heave can exceed the dynamic range of a single linkage resulting in the need for a second or even more linkages in series with the first.

It is an object of the present invention to provide installation apparatus and methods which provide stability in the water, and furthermore to restrict the amplitude of vessel heave.

In accordance with a first aspect of the present invention there is provided an apparatus for deployment from a base for installing a component at an underwater facility, comprising a carriage for suspension from the base in use of the apparatus, the carriage being adapted to releasably retain the component and damping means located between the carriage and the base in use for resisting relative motion of the carriage and facility caused by substantially vertical motion of the base.

Advantageously, a cable is included for suspending the carriage from the base.

Preferably, the damping means resists movement of the carriage through the water in use.

The damping means may have substantially neutral buoyancy in use.

Preferably, the damping means are inflatable.

The damping means may be filled with water in use.

The damping means may be are adapted to be filled with water prior to use.

A plurality of damping means may be provided.

An extendable compensation means for accommodating relative motion between the facility and the base may be provided. The compensation means may comprise a parallelogram linkage. The compensation means may be provided between the damping means and the base in use. Alternatively and/or additionally, the compensation means may be provided between the damping means and carriage in use.

In accordance with a second aspect of the present invention, there is provided a method of installing a component at an underwater facility comprising the steps of providing a base, lowering installation apparatus from the base into the water, the apparatus comprising a carriage which releasably retains the component, and providing damping means between the carriage and the base which resists motion through the water.

Preferably, the method includes the step of filling the damping means with water after lowering it into the water.

Preferably, the base is a surface vessel.

Advantageously, the underwater facility is a hydrocarbon production facility.

The invention will now be described, by way of example, with reference to the accompanying drawings, in which:-

FIG. 1 shows a prior art deployment system;

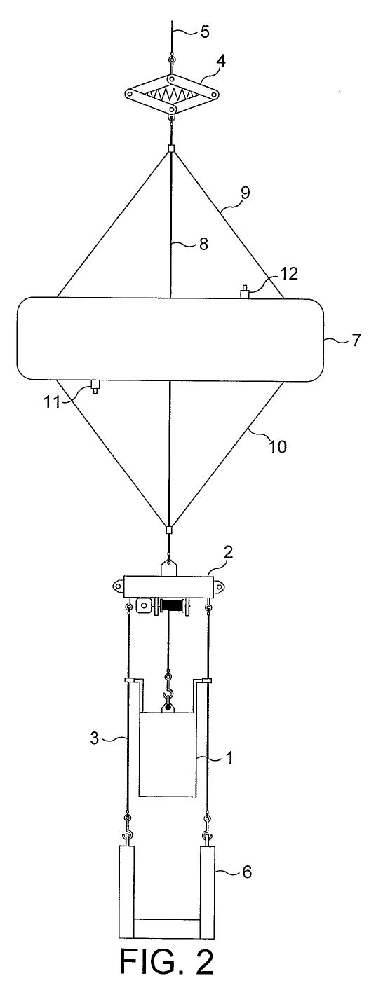

FIG. 2 shows a deployment system in accordance with the present invention; and

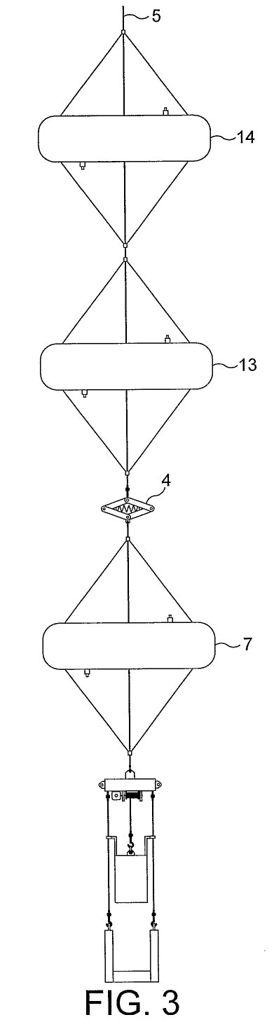

FIG. 3 shows an alternative deployment system embodiment in accordance with the present invention.

FIG. 2 shows a deployment system in accordance with the present invention, where as far as possible, reference numerals have been retained to correspond with those of FIG. 1. In this embodiment, apparatus generally similar to that shown in FIG. 1 is employed, with the addition of damping means located between the parallelogram linkage 4 and the carriage 2. A generally toroidally-shaped bag 7 filled with water is attached to a lifting cable 8, which passes through the hole in the centre of the bag. The attachment is typically provided by a plurality of wires 9, 10 attached symmetrically around the bag 7 at its top and bottom respectively. In this example four wires 9 are used on the top of the bag and a further four wires 10 are symmetrically attached at its bottom. This attachment arrangement provides horizontal stability of the bag 7 to the lifting cable 8. It is possible that additional bags may be incorporated in series with the first bag if necessary.

The arrangement is typically deployed as follows:- The deployment stack 2, not yet attached to the subsea base 6, with the item to be installed 1, an empty bag 7 and parallelogram linkage 4 are all lowered into the water, suspended by the cable 5 from the stern of the vessel. At this stage the bag 7 is ‘deflated’ and its mass is relatively low. The bag 7 is then filled with water via a valve 11, with any air in it being expelled from a valve 12, creating a rigid ring of substantially neutral buoyancy. The whole assembly is then lowered to the sea bed and the guide wires 3 attached to the subsea base 6 by an ROV. The guide wires 3 are then tensioned by the lifting cable 5 so that the parallelogram linkage 4 is in the middle of its dynamic range. Any motion of the lifting cable, such as that resulting from vessel heave is damped both vertically and horizontally by the friction in the water of the bag 7 due to its large surface area, thus preventing oscillations in the system. The dimensions of the neutral buoyancy items are chosen so that there is sufficient friction against the water to provide the required damping to eliminate instability of the system. As the bags are only filled with water during the deployment process, they are easy to handle before deployment.

FIG. 3 shows a further embodiment that can be employed to average out the effect of the vessel heave, thus reducing the amplitude of the dynamic range required by the parallelogram linkage 4, or alternatively reduce the number of linkages required for higher sea states, by fitting at least one bag to the cable above the linkage. It is even possible, as discussed below, to remove the linkage entirely. In the example shown, two additional bags 13 and 14 are attached to the lifting cable 5 between the vessel and the linkage 4, but close, i.e. at the lower end of cable 5, to the linkage 4. The system is deployed in a generally similar manner as described for the first embodiment, with each bag ‘deflated’ until it is lowered into the water, whereby each are then ‘inflated’ in turn with water. The resistance to movement in water of the bags 13 and 14 averages the amplitude heave of the vessel, such that the peak amplitude transmitted to the linkage 4 is substantially reduced. This embodiment may require accommodation, by the inherent elasticity of the lifting cable 5, of the difference between the peak amplitude of the vessel heave and the amplitude transmitted to the linkage 4. The size and number of bags must therefore be chosen, in conjunction with the elasticity of the lifting cable material, the cable diameter and length and the sea depth to determine the dynamic range of the linkage and/or the number of linkages required to operate at a specified sea state. When subsea installations take place at substantial depths, for example two kilometres or more, the elasticity and length of the lifting cable can be sufficient to accommodate all of the heave amplitude, thus allowing the linkage to be dispensed with, as long as the size of each bag is chosen to provide sufficient motion damping to achieve stability of the system.

Although the invention has been described with reference to the two embodiments shown, many other possibilities are applicable within the scope of the invention. For example, although the neutral buoyancy items are here shown as inflatable bags, any items of substantially neutral buoyancy may be employed. Solid items may be advantageous in some circumstances for example as they would be stronger and eliminate the risk of rupture or bursting. Although the items are here described as having toroidal form, any shape is possible so long as it provides stable resistance to movement in the water. Furthermore, theoretically any number of such items could be employed along the length of the cable 5 as necessary. The hoist carriage 2 shown in the figures is exemplary only, and does not affect the scope of the present invention. Similarly, heave compensation devices other than the parallelogram linkages shown may be used without prejudice to the invention.

The invention may be used for both fluid extraction and fluid injection wells.

1. Apparatus for deployment from a base for installing a component at an underwater facility, comprising a carriage for suspension from the base in use of the apparatus, the carriage being adapted to releasably retain the component and a dampener located between the carriage and the base in use for resisting relative motion of the carriage and facility caused by substantially vertical motion of the base.

2. Apparatus according to claim 1, including a cable for suspending the carriage from the base.

3. Apparatus according to claim 1, wherein the dampener resists movement of the carriage through the water in use.

4. Apparatus according to claim 1, wherein the dampener has substantially neutral buoyancy in use.

5. Apparatus according to claim 1, wherein the dampener is inflatable.

6. Apparatus according to claim 1, wherein the dampener is filled with water in use.

7. Apparatus according to claim 5, wherein the dampener is adapted to be filled with water prior to use.

8. Apparatus according to claim 1, wherein the dampener comprises a plurality of dampeners.

9. Apparatus according to claim 1, comprising an extendable compensator for accommodating relative motion between the facility and the base.

10. Apparatus according to claim 9, wherein the compensator comprises a parallelogram linkage.

11. Apparatus according to claim 9, wherein the compensator is provided between the dampener and the base in use.

12. Apparatus according to claim 9, wherein the compensator is provided between the dampener and the carriage in use.

13. A method of installing a component at an underwater facility comprising the steps of providing a base, lowering an installation apparatus from the base into the water, the apparatus comprising a carriage which releasably retains the component, and providing a dampener between the carriage and the base which resists motion through the water.

14. A method according to claim 13, including the step of filling the dampener with water after lowering it into the water.

15. A method according to claim 13, wherein the base is a surface vessel.

16. A method according to claim 13, wherein the underwater facility is a hydrocarbon production facility.

17. (canceled)

18. (canceled)

19. Apparatus according to claim 1, wherein the dampener is adapted to be filled with water prior to use.

20. Apparatus according to claim 10, wherein the compensator is provided between the dampener and the base in use.

21. Apparatus according to claim 10, wherein the compensator is provided between the dampener and the carriage in use.
